(19) United States
(12) Patent Application Publication
(10) Pub. No.: US 2024/0165693 A1
(43) Pub. Date: May 23, 2024

(54) MULTI-PIECE FASTENERS, MULTI-PIECE FASTENER INSTALLATION APPARATUS, AND METHODS OF FASTENING

(71) Applicant: HOWMET AEROSPACE INC., Pittsburgh, PA (US)

(72) Inventor: Amuad Brunet, Bezu-Saint Eloi, Eure (FR)

(21) Appl. No.: 18/552,460

(22) PCT Filed: Apr. 9, 2021
(86) PCT No.: PCT/IB2021/000267

§ 371 Date: Sep. 26, 2023

(51) Int. Cl. B21J 15/02; B21J 15/28; F16B 5/04; F16B 19/05

(52) U.S. Cl. CPC B21J 15/022; B21J 15/285; F16B 5/04; F16B 19/05

(57) ABSTRACT

Multi-piece fasteners, multi-piece fastener installation apparatus, and methods of fastening are provided. The multi-piece fastener comprises a fastening collar and a pin. The fastening collar comprises a first collar end and a second collar end. A collar cavity extends from the first collar end to the second collar end. The pin is configured to be at least partially received by the collar cavity. The pin comprises a first pin end, a second pin end, and a shank extending intermediate the first pin end and the second pin end. The shank comprises a plurality of structural features. A first feature of the plurality of structural features has a first configuration and the second feature of the plurality of structural features has a second configuration. The first configuration and the second configuration differ.

### FIELD OF USE

The present disclosure relates to multi-piece fasteners, multi-piece fastener installation apparatus, and methods of fastening.

### BACKGROUND

Vehicle frames, storage racks, solar panel sub-structures, aircraft parts, and other structures can include numerous mechanical fasteners. For example, a structural fastener can be installed in a bore of a structural component to secure parts together. Properly installing a structural fastener into a bore presents challenges.

### SUMMARY

According to one non-limiting aspect of the present disclosure, a multi-piece fastener is provided. The multi-piece fastener comprises a fastening collar and a pin. The fastening collar comprises a first collar end and a second collar end. A collar cavity extends from the first collar end to the second collar end. The pin is configured to be at least partially received by the collar cavity. The pin comprises a first pin end, a second pin end, and a shank extending intermediate the first pin end and the second pin end. The shank comprises a plurality of structural features. A first feature of the plurality of structural features has a first configuration and the second feature of the plurality of structural features has a second configuration. The first configuration and the second configuration differ.

According to another non-limiting aspect of the present disclosure, a method for fastening is provided. The method comprises inserting a second pin end of a multi-piece fastener into a bore in a structure and forcibly contacting a pull region of a pin of the multi-piece fastener with an installation apparatus. The method comprises measuring a load applied to the multi-piece fastener by the installation apparatus and a stroke length of the collet during installation of the multi-piece fastener with the installation apparatus. A fastening collar of the multi-piece fastener is forcibly contacted with an anvil of the installation apparatus and the pull region is moved distal from the fastening collar, thereby deforming the fastening collar onto a shank of the pin and securing at least a portion of the multi-piece fastener in the structure. The method comprises utilizing the measured load and the measured stroke length to determine whether the collar has been deformed onto the first feature of the shank of the multi-piece fastener during installation of the multi-piece fastener with the installation apparatus.

According to yet another non-limiting aspect of the present disclosure, a multi-piece fastener installation apparatus is provided. The multi-piece fastener installation apparatus comprises a housing defining a housing cavity, an anvil within the housing cavity, a collet within the housing cavity, and a programmable hardware device. The anvil is configured to forcibly contact at least a portion of a collar of a multi-piece fastener. The collet comprises a first collet end adjacent to the anvil. The first collet end is configured to forcibly contact at least a portion of a pull region of a shank of the multi-piece fastener. The programmable hardware device is configured to measure a load applied to the multi-piece fastener by the collet during installation of the multi-piece fastener with the installation apparatus and measure a stroke length of the collet while applying a load during installation of the multi-piece fastener with the installation apparatus. The programmable hardware device is configured to utilize the measured load and the measured stroke length to determine whether the collar of the multi-piece fastener has deformed onto a first feature of a plurality of structural features on the shank of the multi-piece fastener during installation of the multi-piece fastener with the installation apparatus.

It will be understood that the invention disclosed and described in this specification is not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

Features and advantages of the examples presented herein, and the manner of attaining them, will become more apparent, and the examples will be better understood, by reference to the following description taken in conjunction with the accompanying drawings, wherein:

FIG. 1A is a partial cross-sectional side view of a non-limiting example of an acceptable installation of a multi-piece fastener;

FIG. 1B is a partial cross-sectional side view of a non-limiting example of an unacceptable installation of a multi-piece fastener;

FIG. 2 is a partial cross-sectional side view of a non-limiting embodiment of a multi-piece fastener according to the present disclosure;

FIG. 3A is a partial cross-sectional side view of non-limiting embodiments of a multi-piece fastener and a multi-piece fastener installation apparatus according to the present disclosure, shown in a bore in a structure and in a first configuration;

FIG. 3B is a partial cross-sectional side view of the multi-piece fastener and the multi-piece fastener installation apparatus of FIG. 3A, shown in a bore in a structure and in a second configuration;

FIG. 3C is a partial cross-sectional side view of the multi-piece fastener and the multi-piece fastener installation apparatus of FIG. 3A, shown in a bore in a structure and in a third configuration;

FIG. 4A is a curve plotting the measured stroke length versus the measured load for the installation apparatus of FIG. 3A as it moves from the first configuration shown in FIG. 3A to the second configuration shown in FIG. 3B;

FIG. 4B is a curve plotting the measured stroke length versus the measured load for the installation apparatus of FIG. 3A as it moves from the second configuration shown in FIG. 3B to the third configuration shown in FIG. 3C;

FIG. 5 is a curve plotting the measured stroke length versus the measured load during installation of first and second non-limiting embodiments of a multi-piece fastener according to the present disclosure; and

FIG. 6 is a flow chart of a non-limiting embodiment of a method for fastening according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed fastening collars, multi-piece fastening systems, and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

As used herein, “intermediate” means that the referenced element is disposed between two other elements but is not necessarily in contact with those other elements. Accordingly, unless stated otherwise herein, an element that is “intermediate” a first element and a second element may or may not be adjacent to or in contact with the first and/or second elements and additional elements may be disposed between the intermediate element and the first and/or second elements.

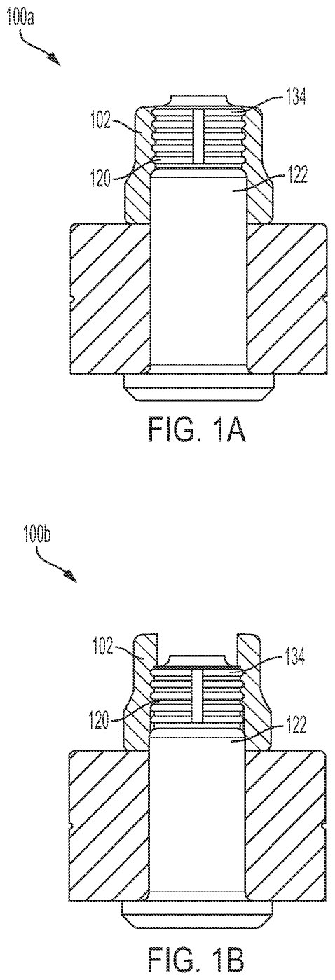

When a structural fastener, such as, for example, a lockbolt is installed into a bore of a structure, a collar of the lockbolt is deformed (e.g., swaged) onto a section of the pin of the fastener. Depending on the user and/or installation tool, an undesired fastener may be used in the installation, the collar may not be acceptably deformed (e.g., a distance of deformation along the axial length of the collar is too short or too long and/or the extent of deformation at a particular point is too much or too little), the collar may be improperly aligned with the pin, or other deficiencies may be present. For example, as illustrated in FIG. 1A, a fastening collar 102 of a lock bolt 100a is shown partially deformed and the fastening collar 102 has been deformed into all the grooves on the shank 122 of the pin 120 of the lockbolt 100a. The configuration shown in FIG. 1A can be considered an acceptable installation in some applications. In contrast, in the configuration shown in FIG. 1B, the fastening collar 102 of lockbolt 100b is partially deformed and the fastening collar 102 has not deformed into all the grooves 134 on the shank 122 of the pin 120 of lockbolt 100. The configuration shown in FIG. 1B can be considered an unacceptable installation in some applications because the fastening collar 102 has been not deformed into a desired minimum number of the grooves 134.

To ensure that a lockbolt has been properly installed, a swage gauge may be used to verify installation of the lockbolt. The swage gauge typically has two different sides: a touch—go side, which includes a first recess having a first size configured to receive the collar, and a touch—no go side, which includes a second recess having a first size configured to receive the collar. Utilizing a swage gauge to verify acceptable installation of a lockbolt requires an additional step after the installation, and it can be time consuming and subjective. Additionally, measuring a total stroke distance of a collet of a lockbolt installation tool or a maximum applied load during installation of a lockbolt may not accurately and efficiently detect whether the fastening collar is properly positioned relative to the pin (e.g., the fastening collar has been swaged onto a desired portion of the pin).

Therefore, the present disclosure provides multi-piece fasteners, multi-piece fastener installation apparatus, and methods of fastening enabling one to efficiently verify the acceptable installation of a structural fastener during the installation procedure and which may not require use of an additional installation verification step with a swage gauge. The installation apparatus and process can increase accuracy and/or the overall efficiency of manufacturing processes since additional fastener installation verification steps may not be needed.

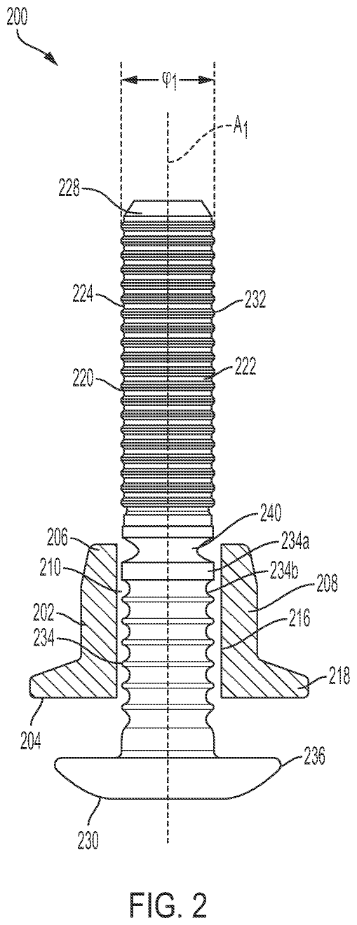

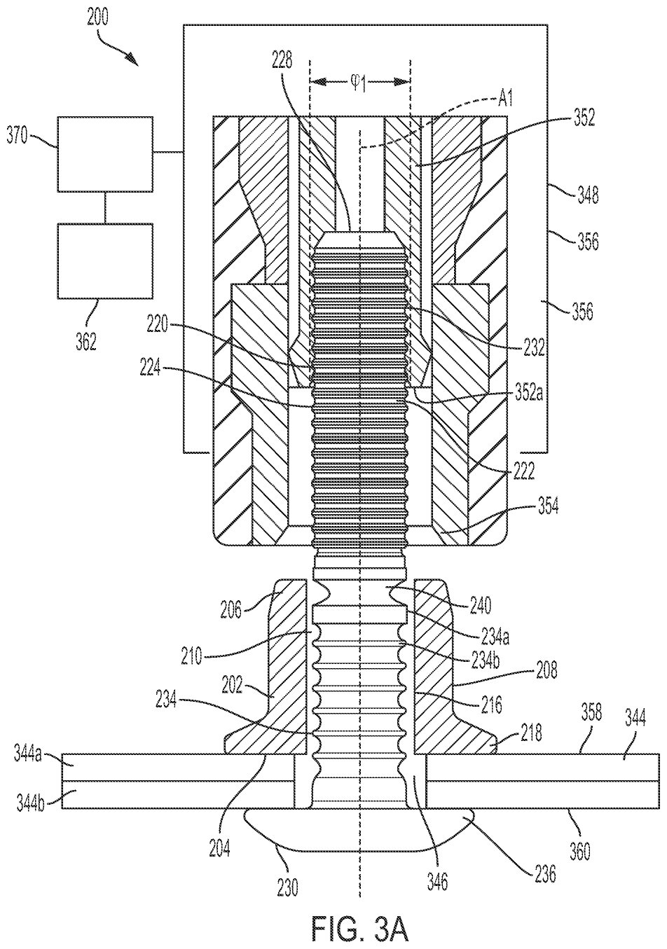

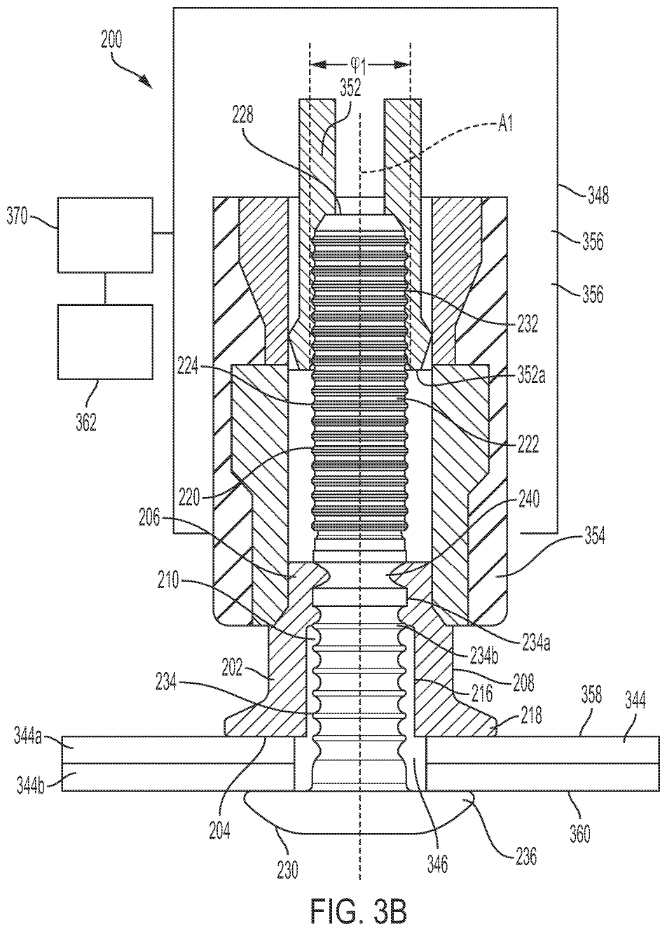

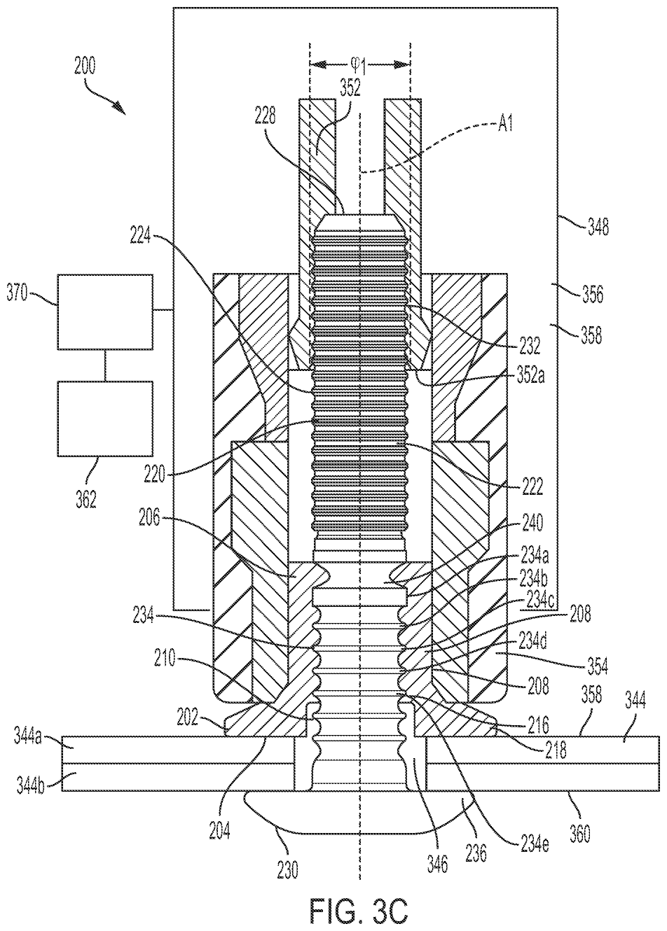

FIG. 2 illustrates a non-limiting embodiment of a multi-piece fastener 200 according to the present disclosure. The multi-piece fastener 200 can be configured to be installed in a bore in a structure (e.g., as illustrated in FIGS. 3A-3C, discussed below). The multi-piece fastener 200 can comprise at least two components, such as, for example, a fastening collar 202 and a pin 220 as illustrated in FIG. 2, or in some non-limiting embodiments, at least three components (not shown). In various non-limiting embodiments, the multi-piece fastener 200 can comprise a two-piece assembly including the fastening collar 202 and the pin 220. In some embodiments, the multi-piece fastener 200 can be at least one of a lockbolt and a blind fastener. For example, the lockbolt can be a structural lockbolt fastener, such as, for example, a structural rivet, a structural bolt, or a structural stud.

The fastening collar 202 can comprise a first collar end 204, a second collar end 206, an elongate portion 208 disposed intermediate the first collar end 204 and the second collar end 206, and a cavity 210 extending through the elongate portion 208 from the first collar end 204 to the second collar end 206. The elongate portion 208 can define a longitudinal axis of the fastening collar 202. A surface 216 of the elongate portion 208 adjacent to the cavity 210 can comprise at least one of a substantially cylindrical region, a threaded region, an annular shoulder, and a groove, depending on the desired application. In various non-limiting embodiments, the fastening collar 202 can be generally cylindrical.

In various non-limiting embodiments, the fastening collar 202 can comprise a flange 218. The fastening collar 202 can be configured in order to engage and/or be received by an anvil of an installation tool while the flange diameter of the flange 218 can inhibit the fastening collar 202 from traversing through a bore in a structure beyond a predetermined distance.

The pin 220 can comprise a first pin end 228, a second pin end 230, and a shank 222. The shank 222 can comprise a shape suitable to be received by the cavity 210 of the fastening collar 202, such as, for example, a generally cylindrical shape. The shank 222 can extend intermediate the first pin end 228 and the second pin end 230 and can be dimensioned so as to be disposed at least partially through the cavity 210. When the shank 222 is inserted in the cavity 210, the first pin end 228 can be disposed adjacent to the second collar end 206, and the second pin end 230 can be disposed adjacent to the first collar end 204. In various non-limiting embodiments, the pin 220 can comprise a head portion 236 configured to inhibit the pin 220 from traversing through a bore in a structure beyond a predetermined distance. In various other non-limiting embodiments, the pin 220 may not comprise a head portion (not shown).

The first pin end 228 can comprise a pull region 224 configured to be engaged by an installation tool (e.g., installation tool 348, as illustrated in FIGS. 3A-3C and discussed below). The pull region 224 can comprise an axial length and in various non-limiting embodiments may not comprise a taper. In other non-limiting embodiments, the pull region 224 can comprise a taper or a reverse taper. For example, as one moves along the pull region 224 away from the head 230 along a longitudinal axis of the pin 220, the diameter of the pull region 224 can decrease. In certain other non-limiting embodiments, the pull region 224 can comprise a reverse taper in which, as one moves along the pull region 224 away from the head 230 along the longitudinal axis of the pin 220, the diameter of the pull region 224 increases. In various embodiments, the pull region 224 can be generally conical.

The pull region 224 can comprise at least one of a generally smooth region, an annular shoulder, a groove, and a bore and/or can comprise another feature configured to be engaged by an installation tool (e.g., installation tool 348, as illustrated in FIGS. 3A-3C and discussed below). For example, in certain non-limiting embodiments the pull region 224 can comprise grooves 232, as illustrated in FIG. 2, that can be engaged by an installation tool.

The shank 222 can define the longitudinal axis of the pin 220. The shank 222 can be configured to engage the fastening collar 202 in order to secure the shank 222 to the fastening collar 202. Upon engagement, the longitudinal axis of the pin 220 and the longitudinal axis of the fastening collar 202 can be substantially aligned along a longitudinal axis, A₁, of the multi-piece fastener 100.

The cavity 210 of the fastening collar 202 can be configured to at least partially receive the shank 222 of the pin 220 therein. For example, the cavity 210 can comprise a shape suitable to receive the shank 222 of the pin 220, such as, for example, a generally cylindrical shape. During and/or after introduction of the shank 222 into the cavity 210, the elongate portion 208, including at least a portion of surface 216, can be at least partially deformed onto the shank 222 responsive to forcible contact between the elongate portion 208 and an installation tool, as described below. The deformation of the elongate portion 208 can secure the fastening collar 202 to the shank 222. In various non-limiting embodiments, the pin 220 can comprise a breakneck groove 240 or other feature configured to fracture upon installation of the multi-piece fastener 200, and the pull region 224 may detach after installation. In various non-limiting embodiments, a diameter, φ₁, of the shank 222 is in a range of 0.06 inches to 4 inches.

The shank 222 comprises structural features 234, such as, for example, one or more annular shoulders, one or more grooves, one or more threads, and combinations thereof. The structural features 234 can engage the surface 216 of the fastening collar 202. The structural features 234 can be external structures on one or more regions of the shank 222. In various non-limiting embodiments, all or a region of the shank 222 includes grooves. For example, as shown in FIG. 2, the structural features 234 are grooves. In various non-limiting embodiments, all or a portion of the shank 222 includes annular shoulders (not shown). In various non-limiting embodiments, all or a region of the shank 222 includes threads (not shown). In certain non-limiting embodiments, all or a region of the shank 222 includes one or more grooves and one or more threads.

Again referring to FIG. 2, a first feature 234a of a plurality of structural features 234 on the shank 222 can have a first configuration, a second feature 234b of the plurality of structural features 234 can have a second configuration, and the first configuration and the second configuration differ. The first and second configurations are configured such that, during installation of the fastener (e.g., deformation of the fastening collar 202 onto the pin 220), the difference between the first and second configurations can be detected. For example, measuring a load applied to the fastening collar 202 during deformation and the stroke distance during the application of the load during installation of the multi-piece fastener 200 can enable the detection of the first and second configurations, and thereby confirm that the fastening collar 202 has been swaged onto the respective structural feature, 234a, 234b.

In various non-limiting multi-piece fastener embodiments in which the plurality of structural features 234 comprise grooves, the first feature 234a can be a first groove and the second feature 234b can be a second groove, and at least one dimension of the first groove and the second groove can differ. For example, the at least one dimension of the first groove and the second groove can comprise a groove crest, a groove depth, or another dimension of the grooves.

In various non-limiting multi-piece fastener embodiments in which the plurality of structural features 234 comprise annular shoulders, the first feature 234a can be a first annular shoulder and the second feature 234b can be a second annular shoulder, and at least one dimension of the first annular shoulder and the second annular shoulder can differ.

In various non-limiting multi-piece fastener embodiments in which the plurality of structural features 234 comprise threads, the first feature 234a can be a first thread and the second feature 234b can be a second thread, and at least one dimension of the first thread and the second thread can differ. For example, the at least one dimension of the first thread and the second thread can comprise a thread depth, an inner thread diameter, an outer thread diameter, or a thread pitch.

The multi-piece fastening system according to the present disclosure can comprise at least one of a metal, a metal alloy, a composite material, or another suitable material. For example, in various embodiments, the multi-piece fastener according to the present disclosure (e.g., fastener 200) can comprise at least one of aluminum, an aluminum alloy, titanium, a titanium alloy, nickel, a nickel alloy, iron, an iron alloy, and a carbon fiber composite material.

As illustrated in FIGS. 3A-3C, the multi-piece fastener 200 can be installed into a bore 346 of a structure 344. As illustrated, the bore 346 can extend through the structure 344 from a first side 368 to a second side 360. In various other non-limiting embodiments, the bore 346 may extend from the first side 368 but not through the entire structure 344, such that a blind hole is formed and a multi-piece fastener according to the present disclosure configured as a blind fastener may be used. In various embodiments, the bore 346 may comprise threads, while in other non-limiting embodiments the bore 346 does not comprise threads.

The structure 344 can comprise, for example, at least one of a metal, a metal alloy, a composite material, or another suitable material. For example, in certain embodiments, the structure 344 can comprise at least one of aluminum, an aluminum alloy, titanium, a titanium alloy, nickel, a nickel alloy, iron, an iron alloy, and a carbon fiber composite material. In various embodiments, the structure 344 into which the multi-piece fastening system 200 is assembled comprises aluminum and/or an aluminum alloy, such as, for example, 7075 aluminum alloy. With reference to the accompanying figures, in various non-limiting embodiments the structure 344 can be configured as at least one of an aerospace component or structure, an automotive component or structure, a transportation component or structure, a building and construction component or structure, or another component or structure.

The structure 344 can comprise a single layer of material or at least two layers of material. For example, as illustrated in FIGS. 3A-3C, the structure 344 can comprise a first material layer 344a and a second material layer 344b. The first material layer 344a can be intermediate the second material layer 344b and the fastening collar 202 when the fastening collar 202 is installed. In various non-limiting embodiments, the first material layer 344a is adjacent to the fastening collar 202.

To facilitate alignment of the multi-piece fastener 200 and the bore 346, a size and/or shape of the first pin end 228 can be configured to readily enter into and move through the bore 346. In various embodiments, a diameter of the head portion 236 can be greater than a diameter of the bore 346 in order to inhibit the pin 220 from further advancing into the bore 346. In various non-limiting embodiments lacking a head portion 236, a diameter of the second pin end 230 can be sized and configured to be less than a diameter of the bore 346, thereby allowing the second pin end 230 to readily move into and through the bore 346.

As illustrated in FIG. 3A, the first pin end 228 of the pin 220 was positioned in alignment with the second side 360 of the bore 346 before being inserted through the bore 346. In various other non-limiting embodiments in which the multi-piece fastener 200 is configured as a blind fastener without a head portion 236, the second pin end 230 of the pin 220 can be positioned in alignment with the first side 368 of the bore 346 and inserted through the bore 346.

Again referring to FIG. 3A, the fastening collar 202 is shown positioned over the first pin end 228, and the first pin end 228 has been inserted into and through the cavity 210 of the fastening collar 202. The second collar end 206 of the fastening collar 202 has been contacts the first layer 344a of the structure 344. In various non-limiting embodiments in which the pin 220 and the fastening collar 202 comprise threads, inserting the first pin end 228 into the cavity 210 of the fastening collar 202 may require rotation of at least one of the fastening collar 202 and the pin 220.

The fastening collar 202 can be in forcible contact with the structure 344. The forcible contact between the fastening collar 202 and the structure 344 can limit further axial movement of the fastening collar 202 relative to the pin 220 along the longitudinal axis, A₁.

Referring again to FIG. 3A, a multi-piece fastener installation apparatus 348 is provided. The installation apparatus 348 comprises a housing 356 defining a housing cavity 358, an anvil 354 positioned within the housing cavity 358, a collet 352 positioned within the housing cavity 358, and a programmable hardware device (PHD) 370. The anvil 354 can be configured to selectively forcibly contact at least a portion of the fastening collar 202 of the multi-piece fastener 200. The collet 352 comprises a first collet end 352a adjacent to the anvil 354, and the first collet end 352a comprises jaws configured to forcibly contact at least a portion of the pull region 224 of the shank 222 of the multi-piece fastener 200.

In various non-limiting embodiments, the PHD 370 comprises a processor operatively coupled to a memory. The PHD 370 is configured to (e.g., comprises sensors and/or circuitry configured to) measure a load applied to the multi-piece fastener 200 by the collet 352 during installation of the multi-piece fastener 200 with the installation apparatus 348, hereby determining a measured load. The collet 352 can retract within the anvil 354 and thereby cause forcible contact between the anvil 354 and the fastening collar 202. The measured load can be a direct measurement of a load applied during installation to the collet 352 by a device (e.g., motor, actuator) and/or the measured load can be an indirect measurement of load applied during installation to the collet 352 by measuring a force applied to the anvil 352 as a result of the forcible contact between the fastening collar 202 and the anvil 354.

The PHD 370 is further configured to measure a stroke length of the collet 352 while applying a load to the collet 352 during installation of the multi-piece fastener 200 with the installation apparatus 348, thereby determining a measured stroke length. The measured stroke length can be an absolute distance the collet 352 moves along the longitudinal axis, A₁ and/or a relative distance the collet 352 moves along the longitudinal axis, A₁, relative to the anvil 354 during the installation process.

The PHD 370 also can be configured to utilize the measured load and the measured stroke length to determine whether, during installation of the multi-piece fastener 200 with the installation apparatus 348, the fastening collar 202 has deformed onto the first feature 234a, the second feature 234b, and/or another feature of the plurality of structural features 234 on the shank 222 of the multi-piece fastener 200. The PHD 370 can determine the number of structural features 234 on the shank 222 onto which the fastening collar 202 has deformed in the installation process. The PHD 370 can be configured to normalize the measured load and the measured stroke length based on a determination that the fastening collar 202 of the multi-piece fastener 200 has deformed onto the first feature 234a of the plurality of structural features 234 on the shank 222. The PHD 370 also can utilize the measurements and plot a curve of measured stroke length versus measured load during the installation process. The PHD 370 can then determine whether or not the multi-piece fastener 200 has been installed acceptably by: comparing the number of structural features 234 onto which the fastening collar 220 has deformed to a predetermined quantity of structural features threshold; comparing the measured stroke length to a predetermined stroke length threshold; comparing the measured load to a predetermined load threshold; analyzing the measured stroke versus measured load curve; and/or determining whether or not the measured stroke versus load curve passes thru a predefined check box or other characteristic point.

The PHD 370 can output the determination whether or not the multi-piece fastener 200 has been installed acceptably to a display 362, which is in signal communication with the PHD 370. For example, the display 362 can be configured to display a first indicia signifying that the fastening collar 202 of the multi-piece fastener 200 has deformed onto the first feature 234a of the plurality of structural features 234 or a second indicia signifying that the fastening collar 202 of the multi-piece fastener 200 has not deformed onto the first feature 234a of the plurality of structural features 234, based on the determination by the PHD 370 whether the fastening collar 202 of the multi-piece fastener 200 has deformed onto the first feature 234a on the shank 222 of the multi-piece fastener 200 during its installation with the installation apparatus 348. In various non-limiting embodiments, the display 362 can be configured to display a first indicia signifying that the multi-piece fastener 200 has been acceptably installed (based on the particular applicable standard) or a second indicia signifying that the multi-piece fastener 200 has not been acceptably installed.

Referring again to FIG. 3A, a collet 352 of the installation tool 348 has engaged the shank 222 of the pin 220 of the multi-piece fastener 200. For example, the collet 352 can be configured to retract within the installation tool 348, which causes the collet 352 to forcibly contact an anvil 354 of the installation tool 348. Thereafter, the collet 352 can close around and forcibly contact the pull region 224 of pin 220, thereby engaging the pull region 224. Upon engagement, the collet 352 can apply an axial force to the pull region 224 of the pin 220, which can decrease a gap, if present, between the first layer 344a and the second layer 344b of the structure 344 and create forcible contact between the fastening collar 202 and the structure 344.

The anvil 354 can at least partially deform the fastening collar 202 onto the shank 222 of the pin 220, thereby securing the fastening collar 202 to the shank 222. For example, referring to FIG. 3B, the collet 352 can retract within the installation tool 348 and move the pin 220 as the collet 352 retracts due to the contact between the pull region 224 and the collet 352. As the collet 352 retracts, the anvil 354 forcibly contacts the fastening collar 202. After a predetermined force is achieved, the elongate portion 208 can be at least partially deformed responsive to the forcible contact between the anvil 354 and the fastening collar 202. For example, the elongate portion 208 can be at least partially swaged onto at least a portion of the structural features 234 on the shank 222. As illustrated in FIG. 3B, the elongate portion 208 has been swaged onto at least the first feature 234a.

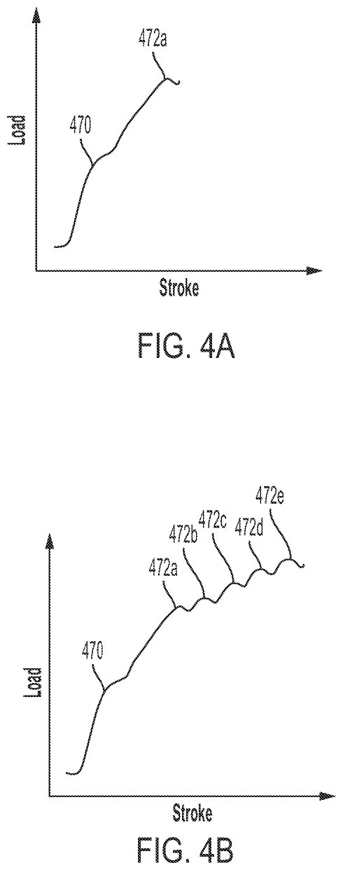

During the retraction of the collet 352, the load applied to the collet 352 (i.e., measured load) and the stroke length of the collet 352 (i.e., measured stroke length) can be determined by the PHD 370. For example, as shown in FIG. 4A, the PHD 370 has plotted a curve 470 of the measured stroke length versus the measured load as the installation process progresses from the configuration shown in FIG. 3A to the configuration shown in FIG. 3B The fastening collar 202 was swaged onto the first feature 234a at area 472a on the curve 470.

The collet 352 can continue to retract to the position illustrated in FIG. 3C. As the collet 352 continues to retract, the anvil 354 forcibly contacts and deforms more of the fastening collar 202. For example, the elongate portion 208 can be at least substantially swaged onto a substantial number of the structural features 234 on the shank 122. As illustrated in FIG. 3C, the elongate portion 208 has been swaged onto the first feature 234a, the second feature 234b, a third feature 234c, a fourth feature 234d, and a fifth feature 234e of the plurality of features 234 on shank 122.

As illustrated in FIG. 3C, after installation of the multi-piece fastener 200 into the structure 344, the fastening collar 202 and the head portion 236 of the pin 220 can apply a clamping force to the structure 344, thereby securing the two-piece fastener 200 to the structure 344. In certain non-limiting embodiments, the pin 220 may fracture along the breakneck groove 240 after installation into the structure 344.

During the continued retraction of the collet 352, the load applied to the collet 352 (i.e., measured load) and the stroke length of the collet 352 (i.e., measured stroke length) can be measured by the PHD 370. For example, as shown in FIG. 4B, the PHD 370 has continued to plot the curve 470 of the measured stroke length versus the measured load as the installation process progresses from the configuration shown in FIG. 3B to the configuration shown in FIG. 3C. The fastening collar 202 was deformed onto the second feature 234b at area 472b on the curve 470. The fastening collar 202 was deformed onto the third feature 234c at area 472c on the curve 470. The fastening collar 202 was deformed onto the fourth feature 234d at area 472d on the curve 470. The fastening collar 202 was deformed onto the fifth feature 234e at area 472e on the curve 470.

As can be seen in curve 470 in FIG. 4B, the deformation of the fastening collar 202 onto the first feature 234a creates a different signature 472a in the curve 470 than the deformation of the fastening collar 202 onto the other features 234-e. Determining the signature generated when the fastening collar 202 has deformed onto the first feature 234a can enable a determination of whether the fastening collar 202 has been acceptably installed in the structure. For example, the number of the structural features 234 onto which the fastening collar 202 has deformed during installation of the multi-piece fastener 200 can be determined utilizing the signature 472a of the first feature 234a as a reference. For example, if the first feature 234a is the first in a series of the structural features 234 contacted by the fastening collar 202, the signature 472a of the first feature 234a can be used as an initial counting of structural features. In various non-limiting embodiments, if the first feature 234a is the first in a series of the structural features 234 contacted by the fastening collar 202, the signature 472a of the first feature 234a can be used to verify the thickness of the structure by measuring stroke length from initiation of installation of the collar 202 to the first feature 234a, and by comparing to a predetermined value. However, in certain embodiments the first feature 234a may be in a different position and structural features 234 can be counted prior to the first feature 234a.

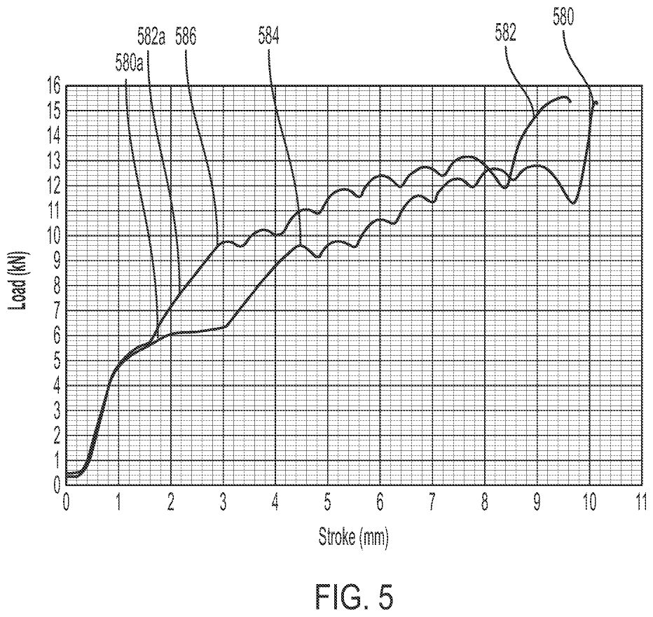

In various non-limiting embodiments, the first feature 234a can be used to normalize the curve of the measured load and the measured stroke length. For example, FIG. 5 illustrates a first curve 580 plotting the measured load and the measured stroke length during the installation of a first multi-piece fastener, and a second curve 582 plotting the measured load and measured stroke length during the installation of a second multi-piece fastener. Region 584 of the first curve 580 corresponds to the point at which a fastening collar of the first multi-piece fastener has swaged onto a first feature of a shank of the first fastener. Region 586 of the second curve 582 corresponds to the point at which a fastening collar of the second multi-piece fastener has swaged onto a first feature of a shank of the second fastener. Both the first and second multi-piece fasteners were installed acceptably. As illustrated, the initial region 580a of the first curve 580 and the initial region 582a of the second curve 582 differ, which can lead to variations in the determination whether or not the respective multi-piece fastener was acceptably installed if only considering measured stroke length or measured load. However, the second region 580b of the first curve 580 and the second region 580b of the second curve 582 are substantially similar. If the first curve 580 and the second curve 582 are normalized utilizing the region 584 and the region 586 as a reference, respectively, they are substantially similar. Therefore, normalizing based on deformation of the fastening collar 202 onto the first feature can enable a more accurate determination of whether or not the multi-piece fastener 200 has been acceptably installed.

In various non-limiting embodiments, the first and second curves 580 and 582 can be aligned at a measured load of the signature 472a of the first feature 234a (e.g., the measured load at the center of the first signature 472a). Thereafter, the stroke length prior to the first signature 472a can be determined and compared to a predetermined value to determine if the collar 202 is in a desired position relative to the pin 220, which can also be used to determine the thickness of the structure 344. Thereafter, the stroke length after the first signature 472a until the end of installation can be determined and compared to a predetermined value to determine if the collar 202 has been installed to a desired level.

The deformation of the elongate portion 208 can secure the fastening collar 202 to the pin 220, and thereby secure the multi-piece fastener 200 to at least a portion of the structure 344. In that way, for example, the first material layer 344a and the material second layer 344b of the structure 344 are secured together (e.g., inhibited from axial movement along the longitudinal axis, A₁, of the multi-piece fastener 200).

In various non-limiting embodiments, the installation tool can be a puller tool, as illustrated in FIGS. 3A-3C, or a squeezer tool (not shown). For example, as is known in the art, a squeezer tool can simultaneously apply a compressive force to the fastening collar 202 and the second pin end 230 of the pin 220. The compressive force can deform the fastening collar 202 onto the shank 222 of the pin 220, thereby securing the fastening collar 202 onto the shank 222.

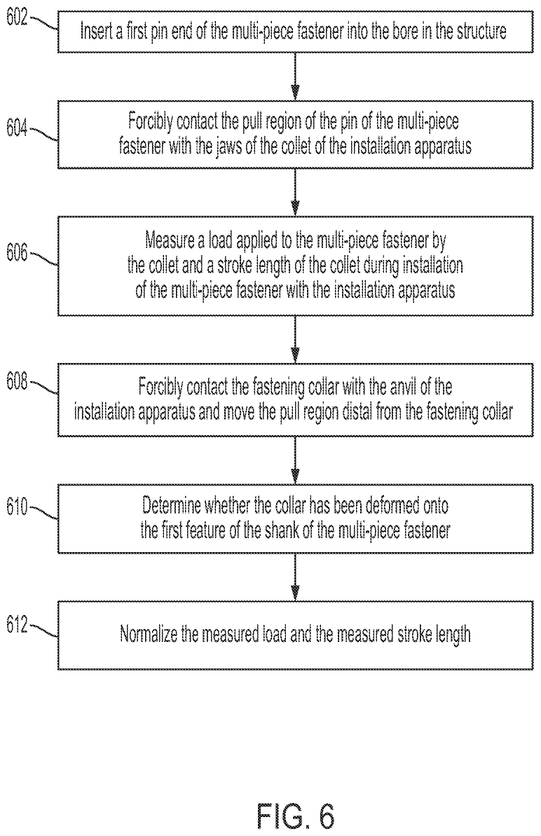

Referring to FIG. 6, in various non-limiting embodiments, a multi-piece fastener according to the present disclosure can be installed in a method for fastening a structure. At step 602, a first pin end 228 of the multi-piece fastener 200 is inserted into the bore 346 in the structure 344. At step 604, the pull region of the pin of the multi-piece fastener is forcibly contacted with the jaws of a collet of an installation apparatus. At step 606, a load applied to the multi-piece fastener by the collet (i.e., measured load) and a stroke length of the collet (i.e., measured stroke length) are measured during installation of the multi-piece fastener with the installation apparatus. The fastening collar is forcibly contacted with an anvil of the installation apparatus and the pull region is moved distal from the fastening collar utilizing the collet of the fastening collar installation apparatus, thereby deforming the fastening collar onto the shank of the pin and securing at least a portion of the multi-piece fastener in the structure at step 608. At step 610, the measured load and the measured stroke length are used to determine whether the collar has been deformed onto the first feature of the shank of the multi-piece fastener during installation of the multi-piece fastener with the installation apparatus. In various non-limiting embodiments, as shown at step 612, the measured load and the measured stroke length can be normalized based on a determination that the collar of the multi-piece fastener has deformed onto the first feature of a plurality of structural features on the shank. In various non-limiting embodiments, indicia can be displayed on a display of the installation apparatus to indicate whether the multi-piece fastener has been acceptably installed.

Various aspects of the invention include, but are not limited to, the aspects listed in the following numbered clauses.

1. A multi-piece fastener comprising:
a fastening collar comprising a first collar end and a second collar end, wherein a collar cavity extends from the first collar end to the second collar end; and
a pin configured to be at least partially received by the collar cavity, the pin comprising
   a first pin end,
   a second pin end, and
   a shank extending intermediate the first pin end and the second pin end,
   wherein the shank comprises a plurality of structural features; and
   wherein a first feature of the plurality of structural features has a first configuration, a second feature of the plurality of structural features has a second configuration, and the first configuration and the second configuration differ.
      2. The multi-piece fastener of clause 1, wherein the plurality of structural features comprises a first groove and a second groove, and at least one dimension of the first groove and the second groove differ.
      3. The multi-piece fastener of clause 2, wherein the at least one dimension of the first groove and the second groove is selected from groove crest and a groove depth.
      4. The multi-piece fastener of any of clause 1, wherein the plurality of structural features comprises a first annular shoulder and a second annular shoulder, and at least one dimension of the first annular shoulder and the second annular shoulder differ.
      5. The multi-piece fastener of clause 1, wherein the plurality of structural features comprises a first thread and a second thread, and at least one dimension of the first thread and the second thread differ.
      6. The multi-piece fastener of clause 5, wherein the at least one dimension of the first thread and the second thread is selected from thread depth, inner thread diameter, outer thread diameter, and thread pitch.
      7. The multi-piece fastener of any of clauses 1-6, wherein the fastening collar is generally cylindrical.
      8. The multi-piece fastener of any of clauses 1-7, wherein the fastening collar comprises a flange, the first pin end comprises a head portion, and the second pin end comprises a pull region.
      9. The multi-piece fastener of any of clauses 1-8, wherein the multi-piece fastener is adapted to be installed in a bore in a structure.
      10. The multi-piece fastener of clause 9, wherein the structure is at least one of an aerospace part or component, an automotive part or component, a transportation part or component, and a building and construction part or component.
      11. The multi-piece fastener of any of clauses 1-10, wherein the multi-piece fastener comprises at least one of a metal, a metal alloy, and a composite.
      12. The multi-piece fastener of any one of clauses 1-11, wherein a diameter of the shank is in a range of 0.06 inches to 4 inches.
      13. A lockbolt comprising the multi-piece fastener of any one of clauses 1-12.
      14. A method for fastening, the method comprising:
inserting a second pin end of the multi-piece fastener of claim 1 into a bore in a structure;
forcibly contacting the pull region of the pin of the multi-piece fastener with an installation apparatus;
measuring a load applied to the multi-piece fastener by the installation apparatus and a stroke length of the collet during installation of the multi-piece fastener with the installation apparatus;
forcibly contacting the fastening collar with an anvil of the installation apparatus and moving the pull region distal from the fastening collar, thereby deforming the fastening collar onto the shank of the pin and securing at least a portion of the multi-piece fastener in the structure; and
utilizing the measured load and the measured stroke length to determine whether the collar has been deformed onto the first feature of the shank of the multi-piece fastener during installation of the multi-piece fastener with the installation apparatus.
   15. The method of clause 14, further comprising normalizing the measured load and the measured stroke length based on a determination that the collar of the multi-piece fastener has deformed onto the first feature of a plurality of structural features on the shank.
   16. A multi-piece fastener installation apparatus comprising:
a housing defining a housing cavity;
an anvil within the housing cavity, the anvil configured to forcibly contact at least a portion of a collar of a multi-piece fastener;
a collet within the housing cavity, the collet comprising a first collet end adjacent to the anvil, the first collet end configured to forcibly contact at least a portion of a pull region of a shank of the multi-piece fastener; and
a programmable hardware device configured to
   measure a load applied to the multi-piece fastener by the collet during installation of the multi-piece fastener with the installation apparatus,
   measure a stroke length of the collet while applying a load during installation of the multi-piece fastener with the installation apparatus, and
   utilize the measured load and the measured stroke length to determine whether the collar of the multi-piece fastener has deformed onto a first feature of a plurality of structural features on the shank of the multi-piece fastener during installation of the multi-piece fastener with the installation apparatus.
      17. The multi-piece fastener installation apparatus of clause 16, wherein the first feature is different than a second feature of the plurality of structural features on the shank of the multi-piece fastener.
      18. The multi-piece fastener installation apparatus of any of clauses 16-17, further comprising:
a display in signal communication with the programmable hardware device, the display configured to display a first indicia that the collar of the multi-piece fastener has deformed onto the first feature of the plurality of structural features, a second indicia that the collar of the multi-piece fastener has not deformed onto the first feature of the plurality of structural features, or a combination of the first and second indicia, based on the determination of whether the collar of the multi-piece fastener has deformed onto the first feature of a plurality of structural features on the shank of the multi-piece fastener during installation of the multi-piece fastener with the installation apparatus by the programmable hardware device.
   19. The multi-piece fastener installation apparatus of any of clauses 16-19, wherein the programmable hardware device is further configured to normalize the measured load and the measured stroke length based on a determination that the collar of the multi-piece fastener has deformed onto the first feature of a plurality of structural features on the shank.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described fasteners, structures, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A multi-piece fastener comprising:
a fastening collar comprising a first collar end and a second collar end, wherein a collar cavity extends from the first collar end to the second collar end; and
a pin configured to be at least partially received by the collar cavity, the pin comprising
a first pin end,
a second pin end, and
a shank extending intermediate the first pin end and the second pin end,
wherein the shank comprises a plurality of structural features; and
wherein a first feature of the plurality of structural features has a first configuration, a second feature of the plurality of structural features has a second configuration, and the first configuration and the second configuration differ.

2. The multi-piece fastener of claim 1, wherein the plurality of structural features comprises a first groove and a second groove, and at least one dimension of the first groove and the second groove differ.

3. The multi-piece fastener of claim 2, wherein the at least one dimension of the first groove and the second groove is selected from groove crest and a groove depth.

4. The multi-piece fastener of claim 1, wherein the plurality of structural features comprises a first annular shoulder and a second annular shoulder, and at least one dimension of the first annular shoulder and the second annular shoulder differ.

5. The multi-piece fastener of claim 1, wherein the plurality of structural features comprises a first thread and a second thread, and at least one dimension of the first thread and the second thread differ.

6. The multi-piece fastener of claim 5, wherein the at least one dimension of the first thread and the second thread is selected from thread depth, inner thread diameter, outer thread diameter, and thread pitch.

7. The multi-piece fastener of claim 1, wherein the fastening collar is generally cylindrical.

8. The multi-piece fastener of claim 1, wherein the fastening collar comprises a flange, the first pin end comprises a head portion, and the second pin end comprises a pull region.

9. The multi-piece fastener of claim 1, wherein the multi-piece fastener is adapted to be installed in a bore in a structure.

10. The multi-piece fastener of claim 9, wherein the structure is at least one of an aerospace part or component, an automotive part or component, a transportation part or component, and a building and construction part or component.

11. The multi-piece fastener of claim 1, wherein the multi-piece fastener comprises at least one of a metal, a metal alloy, and a composite.

12. The multi-piece fastener of claim 1, wherein a diameter of the shank is in a range of 0.06 inches to 4 inches.

13. A lockbolt comprising the multi-piece fastener of claim 1.

14. A method for fastening, the method comprising:
inserting a second pin end of the multi-piece fastener of claim 1 into a bore in a structure;
forcibly contacting the pull region of the pin of the multi-piece fastener with an installation apparatus;
measuring a load applied to the multi-piece fastener by the installation apparatus and a stroke length of the collet during installation of the multi-piece fastener with the installation apparatus;
forcibly contacting the fastening collar with an anvil of the installation apparatus and moving the pull region distal from the fastening collar, thereby deforming the fastening collar onto the shank of the pin and securing at least a portion of the multi-piece fastener in the structure; and
utilizing the measured load and the measured stroke length to determine whether the collar has been deformed onto the first feature of the shank of the multi-piece fastener during installation of the multi-piece fastener with the installation apparatus.

15. The method of claim 14, further comprising normalizing the measured load and the measured stroke length based on a determination that the collar of the multi-piece fastener has deformed onto the first feature of a plurality of structural features on the shank.

16. A multi-piece fastener installation apparatus comprising:
a housing defining a housing cavity;
an anvil within the housing cavity, the anvil configured to forcibly contact at least a portion of a collar of a multi-piece fastener;
a collet within the housing cavity, the collet comprising a first collet end adjacent to the anvil, the first collet end configured to forcibly contact at least a portion of a pull region of a shank of the multi-piece fastener; and
a programmable hardware device configured to
measure a load applied to the multi-piece fastener by the collet during installation of the multi-piece fastener with the installation apparatus,
measure a stroke length of the collet while applying a load during installation of the multi-piece fastener with the installation apparatus, and
utilize the measured load and the measured stroke length to determine whether the collar of the multi-piece fastener has deformed onto a first feature of a plurality of structural features on the shank of the multi-piece fastener during installation of the multi-piece fastener with the installation apparatus.

17. The multi-piece fastener installation apparatus of claim 16, wherein the first feature is different than a second feature of the plurality of structural features on the shank of the multi-piece fastener.

18. The multi-piece fastener installation apparatus of claim 16, further comprising:
a display in signal communication with the programmable hardware device, the display configured to display a first indicia that the collar of the multi-piece fastener has deformed onto the first feature of the plurality of structural features, a second indicia that the collar of the multi-piece fastener has not deformed onto the first feature of the plurality of structural features, or a combination of the first and second indicia, based on the determination of whether the collar of the multi-piece fastener has deformed onto the first feature of a plurality of structural features on the shank of the multi-piece fastener during installation of the multi-piece fastener with the installation apparatus by the programmable hardware device.

19. The multi-piece fastener installation apparatus of claim 16, wherein the programmable hardware device is further configured to normalize the measured load and the measured stroke length based on a determination that the collar of the multi-piece fastener has deformed onto the first feature of a plurality of structural features on the shank.
